(19) United States
(12) Patent Application Publication
(10) Pub. No.: US 2003/0084816 A1
(43) Pub. Date: May 8, 2003

(54) Multicolor dye set with high light-fastness

(76) Inventors: Yi-Jing Leu, Hsinchu (TW); In-Shan Sir, Kaohsiung (TW); Chia-Hsin Chien, Taoyuan (TW); Yu-Chang Shen, Taipei (TW)

Correspondence Address: RABIN & BERDO, P.C., Suite 500, 1101 14th Street, N.W., Washington, DC, 20005, US

(21) Appl. No.: 10/178,836

(22) Filed: Jun. 25, 2002

(30) Foreign Application Priority Data
Jul. 20, 2001 (TW) 090117853

(51) Int. Cl. C09D 11/02; C09B 1/00; D06P 1/00

(52) U.S. Cl. 106/31.27; 106/31.49; 106/31.58; 106/31.43; 8/638

(57) ABSTRACT

An ink-jet ink of multicolor dye set with high light-fastness comprises: a multicolor dye set, a surfactant, and an aqueous solvent. The multicolor dye set includes a cyan dye set, a magenta dye set, and a yellow dye set. The cyan dye set comprises direct blue 199 dye, acid blue 9 dye, and direct blue 86 dye. The magenta dye set comprises reactive red 180 dye, acid red 52 dye, and reactive red dye. The yellow dye set comprises acid yellow 23 and Milliken Palmer yellow R dye. When the multicolor dye set of the invention is applied in ink-jet printing process, the high-quality printed image possesses high light-fastness, high chroma, broad color gamut.

This application incorporates by reference of Taiwan application Serial No. 090117853, filed Jul. 20, 2001.

### BACKGROUND OF THE INVENTION

1. Field of the Invention

The invention relates in general to a multicolor dye set with high light-fastness, and more particularly to a multicolor dye set with high light-fastness suitable for use in ink-jet printing process.

2. Description of the Related Art

Generally, the multicolor inkjet dye set consists of magenta ink, cyan ink, yellow ink, and black ink. Most of multicolor inkjet dye sets are water-based dye sets in the commercial market. Recently, two more colors, light magenta ink and light cyan ink, are adopted for adding variety to the inkjet ink. Even light yellow ink is added in the inkjet ink later. The composition of four-color, six-color, or sever-color inkjet ink consists of at least one dye or colorant, water, organic solvent, and other additives. However, the printing image formed by the water-base inkjet dye set has poor water-fastness and light-fastness quality. Hence, the colorant inkjet ink with better water-fastness and light-fastness quality is aggressively developed in the recent years. Although the colorant inkjet ink has better water-fastness and light-fastness quality, a need remains for adding the appropriate dispersant and binder. Also, the colorant particle with larger particle size than dye is much easier to precipitate and aggregate around the orifice. The printing image quality is consequently decreased due to the clogging of orifice. Accordingly, it is very important for the researchers to improve the water-fastness and light-fastness of water-base inkjet dye set.

If the inkjet ink only consists of a single dye, it is easy to cause the plugging of the orifice due to the crystallization of inkjet dye, so that many kinds of humectants are added in the inkjet ink. But, humectant present in the ink also postpones the time required for drying the printing image, and decreases the water-fastness quality of inkjet ink. Addition of humectants are well known and are described in, for example, U.S. Pat. No. 4,631,085 (Kawanishi, et al., 1986), U.S. Pat. No. 4,713,113 (Shimada, et al., 1987), and U.S. Pat. No. 4,737,190 (Shimada, et al., 1988). Also, U.S. Pat. No. 5,925,177 (Carreira, et al., 1999) disclosed an ink composition comprising Acid Yellow 23 dye, urea, and water. Urea presented in the ink avoids the crystallization of Acid Yellow 23 dye, so as to solve the problem of plugging of the orifice.

There are a couple of requirements for a preferred ink and the printing image with better printing quality, such as good crusting resistance, good stability, proper viscosity, proper surface tension, high color saturation, little color-to-color bleed, rapid dry time, etc. During printing, the clogging-of orifice is not going to occur. Additionally, the image printed on the plain paper maintains in a high quality (i.e., high clearness and sharpness, etc.) as printed on the coating paper

Color is represented by two appearance systems. One is color appearance system, precisely specifying colors and showing the relationships among colors, such as Ostwald system, Munsell system, and DIN system. For example, Munsell system, established by an American painter named Munsell, defines colors by the three properties of hue, value, and chroma. Munsell established numerical scales with visually uniform steps for each of these attributes. The other appearance system is color mixing system, which defines the color according to a mixing of three primary colors. So far Commission Internationale de L'Eclairage (CIE) system is the most important color mixing system, and used in the present invention. In the CIE system, the color gamut is defined by L*, a*, and b*, which represent the lightness, hue, and chroma (or saturation) of a color, respectively. The hue of a color represented by a* ranges from green of −a to red of +a, and the chroma (or saturation) of a color symbolized by b* ranges from blue of −b to yellow of +b.

Simply saying, whether the color gamut of ink is board can be determined by the CIE chromaticity diagram. Referring to FIG. 1, which shows color gamut comparisons of two different dye sets. The coordinate X represents hue and denotes as a*, while the coordinate Y represents chroma (or saturation) and denotes as b*. FIG. 1 indicated that color gamut of the first inkjet dye set 101 is broader than that of the second inkjet dye set 102. Consequently, the colors of the first inkjet dye set 101 is more abundant than that of the second inkjet dye set 102. Additionally, the light-fastness of ink can also be determined by the CIE chromaticity diagram. First, measure the optical property of the fresh printed image, and obtain a first chromaticity diagram. Second, the radiation step is performed on the fresh printed image for a certain period of time. The optical property of the fresh printed image is then measured again, and a second chromaticity diagram is obtained. Finally, the first chromaticity diagram is compared to the second chromaticity diagram. Usually, the space covered by the second chromaticity diagram is smaller than the first chromaticity diagram. The space difference represents the light-fastness of the ink. The larger space difference represents the poorer the light-fastness of the ink. Similarly, the water-fastness of ink can also be determined by the CIE chromaticity diagram.

Accordingly, it is an important goal for the manufacturers and researchers to develop ink compositions exhibiting desirable characteristics of broad color gamut, high quality image, high light-fastness, and even high water-fastness.

### SUMMARY OF THE INVENTION

It is therefore an object of the invention to provide a water-based multicolor dye set with high light-fastness.

It is another object of the invention to provide improved ink compositions of multicolor dye set suitable for use in ink-jet printing process. The printed image formed by the ink of the invention has an excellent optical property of high light-fastness. Also, the ink dye set of the invention exhibits a broad color gamut and great printing quality.

Those objects of the invention can be achieved by providing an ink-jet ink of water-based multicolor dye set with high light-fastness, at least comprising a multicolor dye set, a surfactant, and an aqueous solvent. The multicolor dye set includes a cyan dye set, a magenta dye set, and a yellow dye set. The cyan dye set comprises direct blue 199 dye, acid blue 9 dye, and direct blue 86 dye. The magenta dye set comprises reactive red 180 dye, acid red 52 dye, and reactive red dye. The yellow dye set comprises acid yellow 23 and Milliken Palmer yellow R dye.

The surfactant of the invention is 2-pyrrolidone and EHMPD (2-ethyl-2-methylol-1,3-propylene glycol), which both are present in the ink in an amount of about 4.0 wt %, respectively. The ink-jet ink of the invention further comprises organic solvent such as 1,4-butandiol for enhancing the penetration and dispersion of the ink.

The ink-jet ink of the invention further comprises a pH buffer such as potassium hydroxide, a chelating agent such as urea, a humectant such as PEG (polyethylene glycol), a biocide, a preservative and other additives.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows color gamut comparisons of two different dye sets;

FIG. 2 is a chromaticity diagram of the printed image formed by comparative HP-C6578;

FIG. 3 is a chromaticity diagram of the printed image formed by ink dye set of the invention;

FIG. 4 is a chromaticity diagram of the before-irradiation curves of comparative HP-C6578 and ink dye set of the invention; and

FIG. 5 is a chromaticity diagram of the after-irradiation curves of comparative HP-C6578 and ink dye set of the invention.

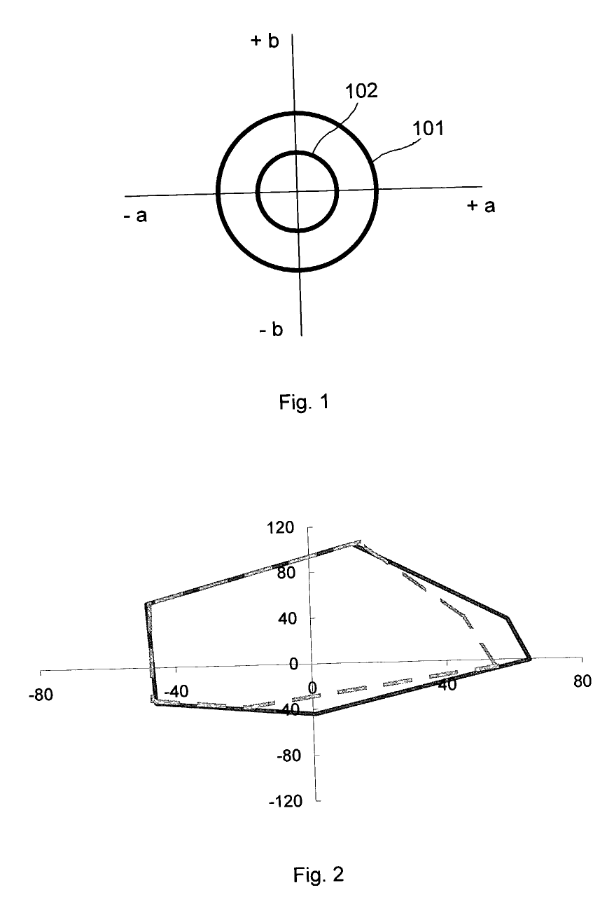

### DETAILED DESCRIPTION OF THE INVENTION

The inkjet ink of multicolor dye set with high light-fastness of the invention at least includes a dye set, and a surfactant, dissolved in a solvent that the solvent consists of water and at least an organic solvent. Preferably, the inkjet ink of the invention further comprises a pH buffer, a chelating agent, a biocide, a humectant, a preservative and other additives (such as an UV absorbent). The multicolor dye set of the invention, including three color dye sets, comprises: (1) cyan dye set—direct blue 199 dye (available from Clariant), acid blue 9 dye (available from Clariant), direct blue 86 dye (available from Bayer), (2) magenta dye set—reactive red 180 dye (available from Bayer), acid red 52 dye (available from Clariant), reactive red (available from Bayer); and (3) yellow dye set—acid yellow 23 dye (available from Clariant), Milliken Palmer yellow R (available from Milliken).

The surfactant of the invention can be one or the combination of 2-pyrrolidone (available from DOW), and EHMPD (2-ethyl-2-methylol-1,3-propylene glycol) (available from Lancaster). The total amount of the surfactant is in the range about 0.01 wt % to 10.0 wt %, and the preferred amount (of each component) is about 4.0 wt %. One or more than one surfactants are added to adjust the viscosity for smoothing the ink supply and ejection, and also to adjust the surface tension of the ink to prevent feathering. Moreover, addition of surfactant(s) also enhances the dispersion of colorant in the ink, and ink penetration to the paper or other recording medium.

All agents of the ink dye set of the invention are dissolved in the solvent like water. The amount of water can be about 50.0 wt %˜85.0 wt %. The solvent further comprises an organic solvent for enhancing the penetration and dispersion of the ink. The organic solvent can be any one or any combination of the following: 13-s-5 (available from Sino-Japan Chemical), 13-s-7 (available from Sino-Japan Chemical), OT-75 (available from KYOWA), 465 (available from Air Product), and 1,4-butandiol (available from Lancaster). The amount of the organic solvent is preferably about 0.5 wt %˜3.0 wt %.

Colorants can only manifest the ideal color in an appropriate range of pH value. Therefore, the ink dye set of the invention preferably further comprises a pH buffer, such as potassium hydroxide (KOH). The amount of potassium hydroxide is preferably about 0.5 wt %.

The ink dye set of the invention can further comprise a chelating agent such as urea, which prevents the crystallization of the salt and the consequential nozzle clogging. The amount of urea is preferably about 0.5 wt %.

To prevent the clogging of the nozzle, humectants can be further added in the ink due to the ability of slowing down the evaporation rate of ink. Preferably, PEG700 (polyethylene glycol 700, available from U.C.C.) is chosen as the humectant added in the dye set of the invention. The amount of PEG700 is about 4.0 wt %.

Additionally, a biocide and a preservative can be further added in the ink to inhibit the growing of the bacteria and prevent the ink from deteriorating. Preferably, SL-700 (available from KYOWA) is chosen as the biocide added in the dye set of the invention. Moreover, it is well known to persons skilled in the art that other additives, such as enhancing light-fastness or the stability in storage, can be further added in the dye set of the invention.

The following examples are conducted to study the physical property of light-fastness of the ink. All parts and percentages are by weight.

The ink dye set used as a control is provided by Hewlett-Packard color cartridge C6578. The compositions of the ink dye set of the invention was prepared by simple mixing of the following ingredients:

| | Ingredient | Supplier | Amount | |
|---|---|---|---|---|
| (1) | Direct blue 199 dye | Clariant | 3 | wt % |
| Cyan | Acid blue 9 dye | Clariant | 1 | wt % |
| | Direct blue 86 dye | Bayer | 0.5 | wt % |
| | Humectant: | U.C.C. | 4.0 | wt % |
| | PEG 700 (polyethylene glycol 700) | | | |
| | Surfactant: 2-pyrrolidone, | DOW | 4.0 | wt % |
| | EHMPD | | 4.0 | wt % |
| | Chelating agent: urea | Lancaster | 0.5 | wt % |
| | pH buffer: potassium hydroxide | Lancaster | 0.5 | wt % |
| | Biocide: SL-700 | KYOWA | 0.5 | wt % |
| | Organic solvent: | | | |
| | 13-S-5 | Sino-Japan | 2 | wt % |
| | | Chemical | | |
| | 13-S-7 | Sino-Japan | 2 | wt % |
| | | Chemical | | |
| | OT-75 | KYOWA | 3 | wt % |
| | 465 | air product | 0.5 | wt % |
| | Water | | | |
| (2) | Reactive red 180 dye | Bayer | 4.0 | wt % |
| Magneta | Acid red 52 dye | Clariant | 0.5 | wt % |
| | Reactive red dye | Bayer | 0.5 | wt % |
| | Humectant: | U.C.C. | 4.0 | wt % |
| | PEG 700 (polyethylene glycol 700) | | | |
| | Surfactant: 2-pyrrolidone, | DOW | 4.0 | wt % |
| | EHMPD | | 4.0 | wt % |
| | Chelating agent: urea | Lancaster | 0.5 | wt % |
| | pH buffer: potassium hydroxide | Lancaster | 0.5 | wt % |
| | Biocide: SL-700 | KYOWA | 0.5 | wt % |
| | Organic solvent: | | | |
| | 13-S-5 | Sino-Japan | 2 | wt % |
| | | Chemical | | |
| | 13-S-7 | Sino-Japan | 2 | wt % |
| | | Chemical | | |
| | OT-75 | KYOWA | 3 | wt % |
| | 465 | air product | 0.5 | wt % |
| | Water | | | |
| (3) | Acid yellow 23 dye | Clariant | 5 | wt % |
| Yellow | Milliken Palmer yellow R dye | Milliken | 1 | wt % |
| | Humectant: | U.C.C. | 4.0 | wt % |
| | PEG 700 (polyethylene glycol 700) | | | |
| | Surfactant: 2-pyrrolidone, | DOW | 4.0 | wt % |
| | EHMPD | | 4.0 | wt % |
| | Chelating agent: urea | Lancaster | 0.5 | wt % |
| | pH buffer: potassium hydroxide | Lancaster | 0.5% | |
| | Biocide: SL-700 | KYOWA | 0.5 | wt % |
| | Organic solvent: | | | |
| | 13-S-5 | Sino-Japan | 2 | wt % |
| | | Chemical | | |
| | 13-S-7 | Sino-Japan | 2 | wt % |
| | | Chemical | | |
| | OT-75 | KYOWA | 3 | wt % |
| | 465 | air product | 0.5 | wt % |
| | Water | | | |

Two ink dye sets (control and experimental) are respectively ejected on the plain paper and coating paper by a commercial inkjet printer. The printed images on the plain paper and coating paper are measured by a simple emitting machine of Microsol, respectively.

### Light-Fastness Test of Control Dye Set (Comparative)

The ink of control dye set (HP-C6578) is ejected by an inkjet printer, thereby forming a printed image on the commercial coating paper. The optical property of the printed image is measured to obtain the chromaticity curve, and the result is presented as the real line in FIG. 2. Then, the printed image is irradiated for 16 hours by the emitting machine of Microsol, wherein the irradiation quantity is equivalent to exposing to sunlight for 10 hours per day in three and half months. After irradiation, the optical property of the printed image is measured to obtain the chromaticity curve, and the result is presented as the dash line in FIG. 2.

By comparing the chromaticity curves of FIG. 2, it indicates that the HP-C6578 color gamut of the after-irradiation curve is narrower than the before-irradiation curve. Therefore, the comparative HP-C6578 exhibited a weak property of light-fastness, particularly weak at the hue relevant to red color (right portion at the X-axis).

### Light-Fastness Test of Experimental Dye Set (of the Invention)

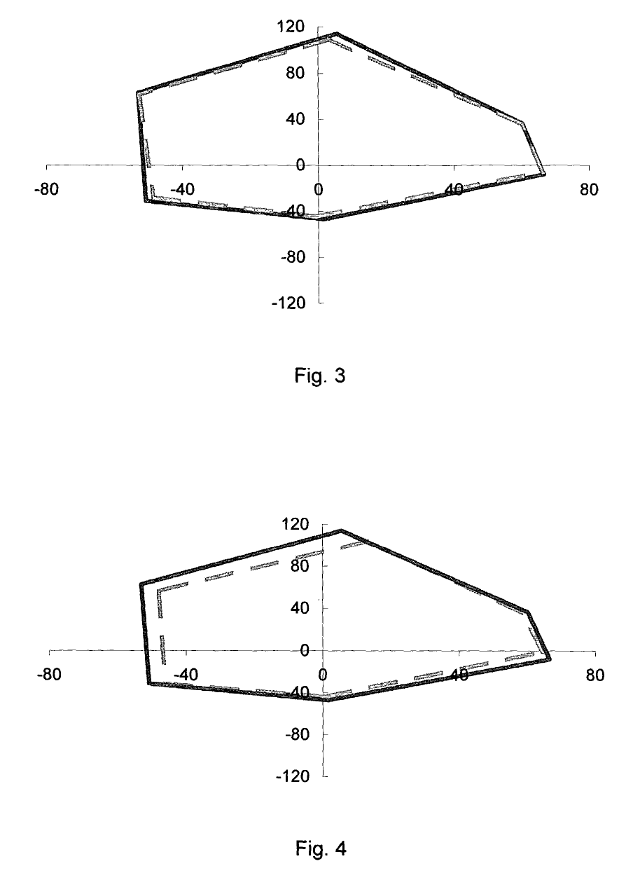

The ink dye set of the invention is ejected by an inkjet printer, thereby forming a printed image on the commercial coating paper. The optical property of the printed image is measured to obtain the chromaticity curve, and the result is presented as the real line in FIG. 3. Then, the printed image is irradiated for 16 hours by the emitting machine of Microsol, wherein the irradiation quantity is equivalent to exposing to sunlight for 10 hours per day in three and half months. After irradiation, the optical property of the printed image is measured to obtain the chromaticity curve, and the result is presented as the dash line in FIG. 3.

FIG. 3 indicates that the color gamut of the after-irradiation curve and the before-irradiation curve are almost identical. Therefore, the ink dye set of the invention exhibited good light-fastness.

### Comparison of Light-Fastness Between Control and Experimental Dye Sets

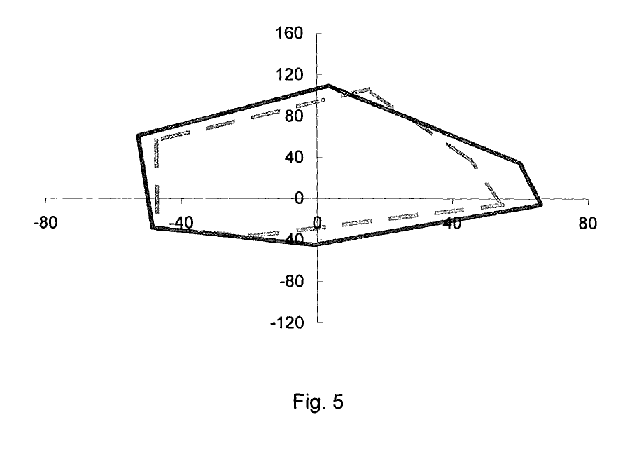

The ink dye set of the invention and the comparative HP-C6578 are ejected by the inkjet printer to form the printed images on the commercial coating papers, respectively. The optical properties of the printed images are measured to obtain the chromaticity curves, and the results are presented in FIG. 4. The real line represents the chromaticity curve of the invention, and the dash line represents the chromaticity curve of HP-C6578. Moreover, the measurement of chroma is performed, and the results are shown in Table 1. Then, the printed images are irradiated for 16 hours by the emitting machine of Microsol, wherein the irradiation quantity is equivalent to exposing to sunlight for 10 hours per day in three and half months. After irradiation, the optical properties of the printed images are measured to obtain the chromaticity curves, and the results are presented in FIG. 5. Also, the real line represents the chromaticity curve of the invention, and the dash line represents the chromaticity curve of HP-C6578.

Table 1 indicates that the chroma of ink dye set of the invention is as good as HP-C6578, even better in colors of magenta and yellow. Also, both results of FIG. 4 and FIG. 5 apparently show that the color gamut of the invention is larger than that of HP-C6578. Therefore, the ink dye set of the invention exhibiting a broader color gamut is able to produce a printed image more abundant in colors.

From the results in the aforementioned experiments, it is therefore apparent that the ink dye set of the invention has the advantages of great light-fastness, broad color gamut, and high quality of printed image.

TABLE 1

| | Ink dye set of the invention | | | HP-C6578 (comparative) | | |
|---|---|---|---|---|---|---|
| | Cyan | Magenta | Yellow | Cyan | Magenta | Yellow |
| Chroma | 56.67 | 66.95 | 114.27 | 58.25 | 64.50 | 107.56 |

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A water-based multicolor dye set with high light-fastness, comprising:
(a) a cyan dye set which comprises direct blue 199 dye, acid blue 9 dye, and direct blue 86 dye;
(b) a magenta dye set which comprises reactive red 180 dye, acid red 52 dye, and reactive red dye; and
(c) a yellow dye set which comprises acid yellow 23 and Milliken Palmer yellow R dye.

2. An ink-jet ink of water-based multicolor dye set with high light-fastness, at least comprising:
a multicolor dye set, comprising:
a cyan dye set which comprises direct blue 199 dye, acid blue 9 dye, and direct blue 86 dye;
a magenta dye set which comprises reactive red 180 dye, acid red 52 dye, and reactive red dye; and
a yellow dye set which comprises acid yellow 23 and Milliken Palmer yellow R dye; and
a solvent, wherein the solvent is an aqueous solution.

3. The ink-jet ink according to claim 2 further comprising a surfactant.

4. The ink-jet ink according to claim 3, wherein the surfactant is 2-pyrrolidone.

5. The ink-jet ink according to claim 3, wherein the surfactant is EHMPD (2-ethyl-2-methylol-1,3-propylene glycol).

6. The ink-jet ink according to claim 3, wherein an amount of the surfactant is about 0.01 wt % to 10.0 wt %.

7. The ink-jet ink according to claim 6, wherein the amount of the surfactant is preferably about 4.0 wt %.

8. The ink-jet ink according to claim 2 further comprising a humectant.

9. The ink-jet ink according to claim 8, wherein the humectant is PEG 700 (polyethylene glycol 700).

10. The ink-jet ink according to claim 9, wherein an amount of the humectant is about 4.0 wt %.

11. The ink-jet ink according to claim 2 further comprising a chelating agent.

12. The ink-jet ink according to claim 11, wherein the chelating agent is urea.

13. The ink-jet ink according to claim 11, wherein an amount of the chelating agent is about 0.5 wt %.

14. The ink-jet ink according to claim 2 further comprising a pH buffer.

15. The ink-jet ink according to claim 14, wherein the pH buffer is potassium hydroxide.

16. The ink-jet ink according to claim 14, wherein an amount of the pH buffer is about 0.5 wt %.

17. The ink-jet ink according to claim 2 further comprising an organic solvent.

18. The ink-jet ink according to claim 17, wherein the organic solvent is 1,4-butandiol.

19. The ink-jet ink according to claim 17, wherein an amount of the organic solvent is about 0.5 wt % to 3.0 wt %.

20. The ink-jet ink according to claim 2, wherein the solvent is water, and an amount of said water is about 50 wt % to 85 wt %.

21. The ink-jet ink according to claim 2 further comprising a biocide.

22. The ink-jet ink according to claim 2 further comprising a preservative.
